(19) United States
(12) Patent Application Publication
(10) Pub. No.: US 2022/0050366 A1
(43) Pub. Date: Feb. 17, 2022

(54) PROJECTION LENS

(71) Applicant: IVIEW DISPLAYS (SHENZHEN) COMPANY LTD., Shenzhen (CN)

(72) Inventors: Guobao Huang, Shenzhen (CN); Steve Yeung, Hong Kong (CN); Zhiqiang Gao, Hong Kong (CN); Yuan Zhao, Shenzhen (CN); Mingnei Ding, Shenzhen (CN)

(21) Appl. No.: 17/512,746

(22) Filed: Oct. 28, 2021

Related U.S. Application Data
(63) Continuation of application No. PCT/CN2019/129521, filed on Dec. 28, 2019.

(30) Foreign Application Priority Data
Aug. 22, 2019 (CN) 201910780081.4

(51) Int. Cl. G03B 21/00; G02B 13/00

(52) U.S. Cl. CPC G03B 21/008; G02B 13/006; G03B 21/142; G02B 13/0045; G02B 13/0065

(57) ABSTRACT

A projection lens includes a DMD chip, an equivalent prism, a vibrating mirror, a first refractive lens group, a diaphragm, and a second refractive lens group that are successively arranged. The first refractive lens group includes a first lens, a triple-cemented lens, and a fifth lens that are successively arranged. The triple-cemented lens includes a second lens, a third lens, and a fourth lens, and the fourth lens is an aspherical lens.

### CROSS-REFERENCE TO RELATED APPLICATIONS

This application is a continuation-application of International (PCT) Patent Application No. PCT/CN2019/129521, filed on Dec. 28, 2019, which claims priority to Chinese Patent Application No. 201910780081.4, filed with the National Intellectual Property Administration of China on Aug. 22, 2019, and entitled “PROJECTION LENS”, the entire contents of which are incorporated herein by reference.

### TECHNICAL FIELD

Embodiments of the present disclosure relate to the technical field of optics, and in particular, relate to a projection lens.

### BACKGROUND

With developments of projection technologies, a stricter requirement is being imposed on resolution of projection images. For 4K projection, a current economic way is to employ a 0.33 DMD (Digital Micromirror Device) chip. This chip has 1.05 million micromirrors which are capable of projecting 1368×768 pixels. Further, a vibrating mirror is configured between the DMD chip and a prism. By periodical vibrations of the vibrating mirror, the number of pixels is visually increased, and thus projection imaging with a 4K resolution is achieved.

During practice of embodiments of the present disclosure, the present inventors have found that the related art has at least the following problem. During configuring the vibrating lens between the DMD chip and the prism, a space needs to be reserved for the vibrating mirror on the back focus of the projection lens, and in this case, a back focal distance of the projection lens is significantly increased, and hence the projection lens has a large size.

### SUMMARY

An embodiment of the present disclosure provides a projection lens. The projection lens includes a DMD chip, an equivalent prism, a vibrating mirror, a first refractive lens group, a diaphragm, and a second refractive lens group that are successively arranged; wherein the first refractive lens group includes a first lens, a triple-cemented lens, and a fifth lens that are successively arranged, wherein the triple-cemented lens includes a second lens, a third lens, and a fourth lens, the fourth lens being an aspherical lens.

Another embodiment of the present disclosure provides a projection lens including a DMD chip, an equivalent prism, a vibrating mirror, a first refractive lens group, a diaphragm, and a second refractive lens group that are successively arranged. The first refractive lens group includes a first lens, a triple-cemented lens, and a fifth lens that are successively arranged, and the second refractive lens group includes a sixth lens, a seventh lens, an eighth lens and a ninth lens that are successively arranged. The triple-cemented lens includes a second lens, a third lens, and a fourth lens, the fourth lens is an aspherical lens. The first lens, the third lens, the fifth lens and the sixth lens are convex lenses, and the second lens, the fourth lens, the seventh lens, the eighth lens and the ninth lens are concave lenses.

### BRIEF DESCRIPTION OF THE DRAWINGS

One or more embodiments are illustrated by way of example, and not by limitation, in the figures of the accompanying drawings, wherein elements/modules and steps having the same reference numeral designations represent like elements/modules and steps throughout. The drawings are not to scale, unless otherwise disclosed.

FIG. 1 is a schematic diagram of an optical structure of a projection lens according to an embodiment of the present disclosure.

FIG. 2 is a schematic diagram of another optical structure of a projection lens according to an embodiment of the present disclosure.

FIG. 3 is a schematic diagram of another optical structure of a projection lens according to an embodiment of the present disclosure.

FIG. 4 is schematic diagram of a full field transfer function value of a projection lens at a resolution of 93 lp/mm according to an embodiment of the present disclosure.

FIG. 5 is schematic diagram of a full field transfer function value of a projection lens at a resolution of 67 lp/mm according to an embodiment of the present disclosure.

FIG. 6 is a schematic diagram of field curvature and distortion of a full field and full wave-band of a projection lens according to an embodiment of the present disclosure.

FIG. 7 is a schematic diagram of vertical chromatic aberration of a full field and full wave-band of a projection lens according to an embodiment of the present disclosure.

FIG. 8 is a schematic diagram of dot columns of a full field of a projection lens according to an embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. In addition, although function module division is illustrated in the schematic diagrams of apparatuses, and in some occasions, module division different from the divisions of the modules in the apparatuses may be used. Further, the terms “first”, “second”, and “third” used in this text do not limit data and execution sequences, and are intended to distinguish identical items or similar items having substantially the same functions and effects.

For ease of definition of the connection structure, the positions of the components are defined using the direction of light path traveling/optical axis as a reference. For example, the direction of light, emitted from a DMD chip and passing through a first refractive lens group 40, is the “front” direction, the direction of a light path emitted from a diaphragm 50 is the “horizontal” direction, and a ninth lens 64 is on the “left” side/edge of an eighth lens 63.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

Specifically, hereinafter, the embodiments of the present disclosure are further illustrated with reference to the accompanying drawings.

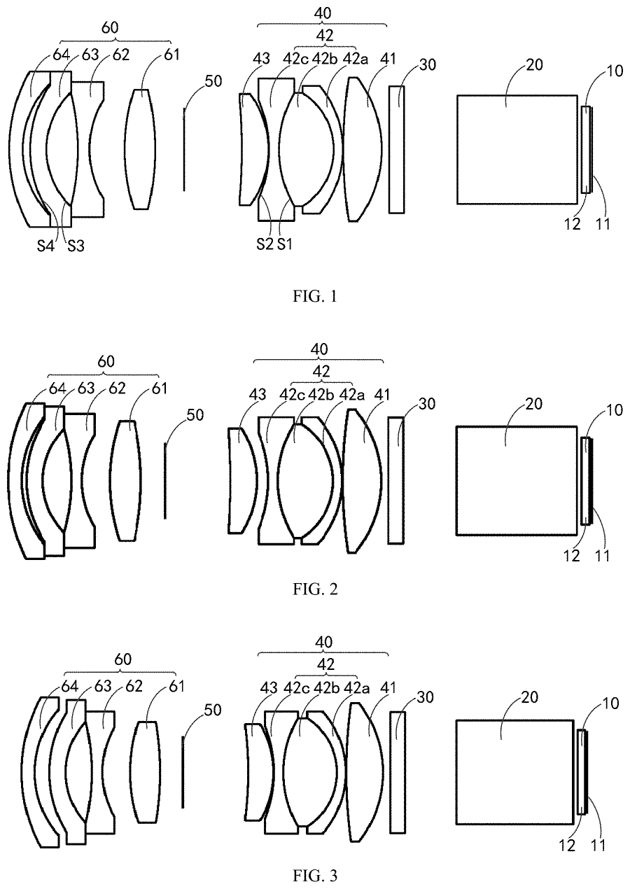

Referring to FIG. 1, a schematic diagram of an optical structure of a projection lens according to an embodiment of the present disclosure is illustrated. The projection lens includes a DMD chip 10, an equivalent prism 20, a vibrating mirror 30, a first refractive lens group 40, a diaphragm 50, and a second refractive lens group 60 that are successively arranged.

The first refractive lens group 40 includes a first lens 41, a triple-cemented lens 42, and a fifth lens 43 that are successively arranged. The triple-cemented lens 42 includes a second lens 42a, a third lens 42b, and a fourth lens 42c, wherein the fourth lens 42c is an aspherical lens.

An embodiment of the present disclosure provides a projection lens. The projection lens includes the vibrating mirror 30 capable of periodically vibrating, thereby achieving 4K high-resolution imaging, and the projection lens is further provided with the first refractive lens group 40 including the triple-cemented lens 42. The triple-cemented lens 42 has good correction capabilities on spherical aberration, chromatic aberration and secondary spectrum, such that a projection image projected from the projection lens has high definition. In addition, in the projection lens according to an embodiment of the present disclosure, since the triple-cemented lens 42 is capable of integrating functions of a plurality of spherical lenses and cemented lenses, the number of spherical single lenses and cemented lenses may be reduced, thereby shortening a total length of the lens.

The DMD chip 10 includes an effective surface 11 of the DMD chip 10, and a protective glass 12 of the DMD chip 10. The DMD chip 10 is configured to process an image signal and generate an image light beam. The image light beam, as illustrated in FIG. 1, is emitted to the left, and passes through the equivalent prism 20, the vibrating mirror 30, the first refractive lens group 40, the diaphragm 50, and the second refractive lens group 60. Therefore, the DMD chip 10, the equivalent prism 20, the vibrating mirror 30, the first refractive lens group 40, the diaphragm 50, and the second refractive lens group 60 are disposed in a same optical axis; and the equivalent prism 20, the vibrating mirror 30, the first refractive lens group 40, the diaphragm 50, and the second refractive lens group 60 are arranged in a light exit direction of the DMD chip 10. In an embodiment of the present disclosure, the DMD chip 10 has a physical resolution of 93 lp/mm, and is a 0.33 DMD chip.

In an experimental design of the embodiment of the present disclosure, the equivalent prism 20 may use parallel flat plates with an equal thickness to achieve equivalence of the state of the light in the prism. The function of the equivalent prism 20 is to deflect the light, and separate an illumination optical path from an imaging optical path to prevent interference.

In an embodiment of the present disclosure, the projection lens further includes a drive motor (not illustrated). The drive motor is connected to the vibrating mirror 30, and configured to drive the vibrating mirror 30 to vibrate. In an embodiment of the present disclosure, the vibrating mirror 30 is controlled to periodically vibrate by driving a motor to output a pulse signal, and in the case that the 0.33 DMD chip with lower cost is used, the resolution of output image may reach 4K.

Specifically, the second lens 42a and the third lens 42b are spherical glass lenses. The fourth lens 42c includes a first surface S1 proximal to the third lens 42b and a second surface S2 proximal to the fifth lens 43, wherein the first surface S1 is a spherical surface, and the second surface S2 is an even-order aspherical surface. The first lens 41 and the fifth lens 43 are spherical glass lenses.

In an embodiment of the present disclosure, the second refractive lens group 60 includes a sixth lens 61, a seventh lens 62, and an eighth lens 63 that are successively arranged, wherein the eighth lens 63 is a weak-focal power aspherical lens.

Specifically, the sixth lens 61 and the seventh lens 62 are spherical glass lenses. The eighth lens 63 is a plastic aspherical lens, and includes a third surface S3 proximal to the seventh lens 62 and a fourth surface S4 distal from the seventh lens 62, wherein the third surface S3 and the fourth surface S4 are both even-order aspherical surfaces.

In an embodiment of the present disclosure, the second refractive lens group 60 further includes a ninth lens 64, wherein the ninth lens 64 is arranged in a light exit direction of the eighth lens 63 and is a spherical glass lens. As illustrated, the first lens 41, the third lens 42b, the fifth lens 43 and the sixth lens 61 may be convex lenses, and the second lens 42a, the fourth lens 42c, the seventh lens 62, the eighth lens 63 and the ninth lens 64 may be concave lenses.

Generally, the lens finally emitting light in the projection lens is a plastic aspherical lens such as the eighth lens 63, and such plastic aspherical lens is subject to film cracking and film peeling during the wipe. Therefore, the projection lens according to an embodiment of the present disclosure further includes the ninth lens 64 made of glass, the eighth lens 63 is placed under the protection of the ninth lens 64. In this way, a user directly wiping the eighth lens 63 is prevented, such that the lens is prevented from film cracking and film peeling off.

In an embodiment of the present disclosure, the first lens 41 has a positive focal power, the second lens 42a has a negative focal power, the third lens 42b has a positive focal power, the fourth lens 42c has a negative focal power, the fifth lens 43 has a positive focal power, the sixth lens 61 has a positive focal power, the seventh lens 62 has a negative focal power, the eighth lens 63 has a negative focal power, and the ninth lens 64 has a negative focal power.

Specifically, the focal power φ7 of the seventh lens 62 satisfies −0.06≤φ7≤0.05, the focal power φ8 of the eighth lens 63 satisfies −0.02≤φ8≤0, and the focal power φ9 of the ninth lens 64 satisfies −0.03≤φ9≤−0.02. In an embodiment of the present disclosure, the focal power of the eighth lens 63 is controlled in a weak range, and the seventh lens 62 and the ninth lens 64 that have a relatively large focal power are respectively arranged both sides of the eighth lens 63 to bear the focal power. In addition, a light refraction angle is effectively corrected by the aspherical surface of the eighth lens 63 to achieve balance of aberration correction, such that the influence of temperature changes on the light deflection angle is compensated, the stability of imaging image quality is ensured, the focus deflection is avoided; and meanwhile, a glass aspherical lens is replaced by a plastic material, and the mold unloading cost and the material cost are saved.

Specifically, as illustrated in Table 1 hereinafter, a group of actual design parameters of the projection lens with a throw ratio of 1.23 according to the embodiment of the present disclosure are listed. In the design parameters, an optical total length of the projection lens may be controlled within a range smaller than 78 mm. An effective focal length of the projection lens is 9.24 mm, and a back focal length of the projection lens, that is, the distance from a vertex of a left side surface of the ninth lens 64 to the effective surface 11 of the DMD chip 10 is 28.1 mm.

TABLE 1

| | Nd | Vd | φ |
|---|---|---|---|
| Ninth lens 64 | 1.85 | 23.8 | −0.025853 |
| Eighth lens 63 | 1.53 | 56.1 | −0.019486 |
| Seventh lens 62 | 1.50 | 81.6 | −0.05787 |
| Sixth lens 61 | 1.90 | 31.3 | |
| Fifth lens 43 | 1.50 | 81.6 | |
| Fourth lens 42c | 1.81 | 40.9 | |
| Third lens 42b | 1.50 | 81.6 | |
| Second lens 42a | 1.65 | 33.8 | |
| First lens 41 | 1.50 | 81.6 | |

In the Table 1, Nd denotes a refractive index of the lens, Vd denotes an Abbe number of the lens, and φ denotes an actual focal power of the lens.

In some embodiments, referring to FIG. 2 and FIG. 3, schematic diagrams of optical structures of other two projection lenses are illustrated. Design parameters of the projection lenses as illustrated in FIG. 2 and FIG. 3 are identical to design parameters of the projection lens as illustrated in FIG. 1. Different from the projection lens as illustrated in FIG. 1, the projection lenses as illustrated in FIG. 2 and FIG. 3 properly adjust an air space of part of lenses in the first refractive lens group 40, or the second refractive lens group 60. For example, in FIG. 2, air space between the fourth lens 42c and the fifth lens 43 is appropriately increased. Alternatively, in FIG. 3, the air space between the eighth lens 63 and the ninth lens 64 is appropriately increased.

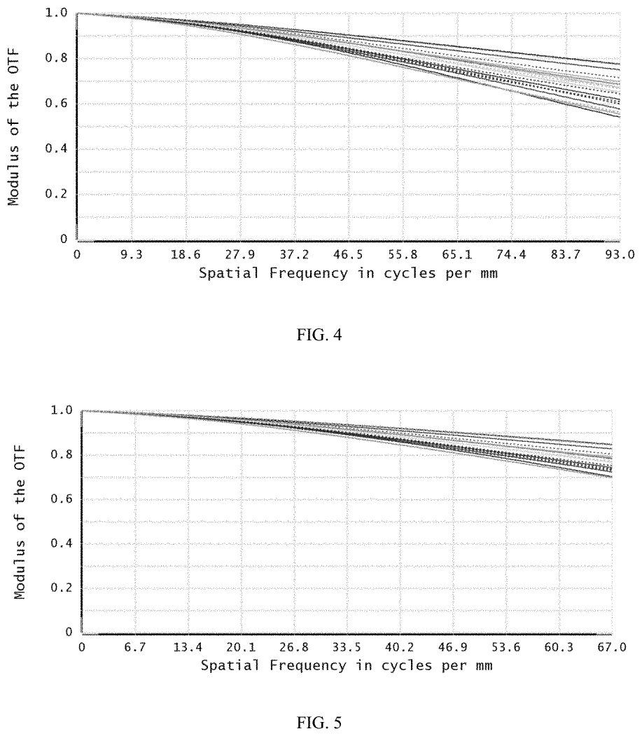

Based on the projection lens as illustrated in FIG. 1 and the actual design parameters of the projection lens as listed in Table 1, an imaging quality diagram of the projection lenses in the full field and full wave-band as illustrated in FIG. 4 to FIG. 8 in the projection system may be acquired.

FIG. 4 is schematic diagram of a full field transfer function value of a projection lens at a resolution of 93 lp/mm according to an embodiment of the present disclosure. As illustrated in FIG. 4, the full field optical transfer function at a spatial frequency of 93 lp/mm is greater than 53%, which is high.

FIG. 5 is schematic diagram of a full field transfer function value of a projection lens at a resolution of 67 lp/mm according to an embodiment of the present disclosure. As illustrated in FIG. 5, the full field optical transfer function (OTF) at a spatial frequency of 67 lp/mm is greater than 70%, which is high.

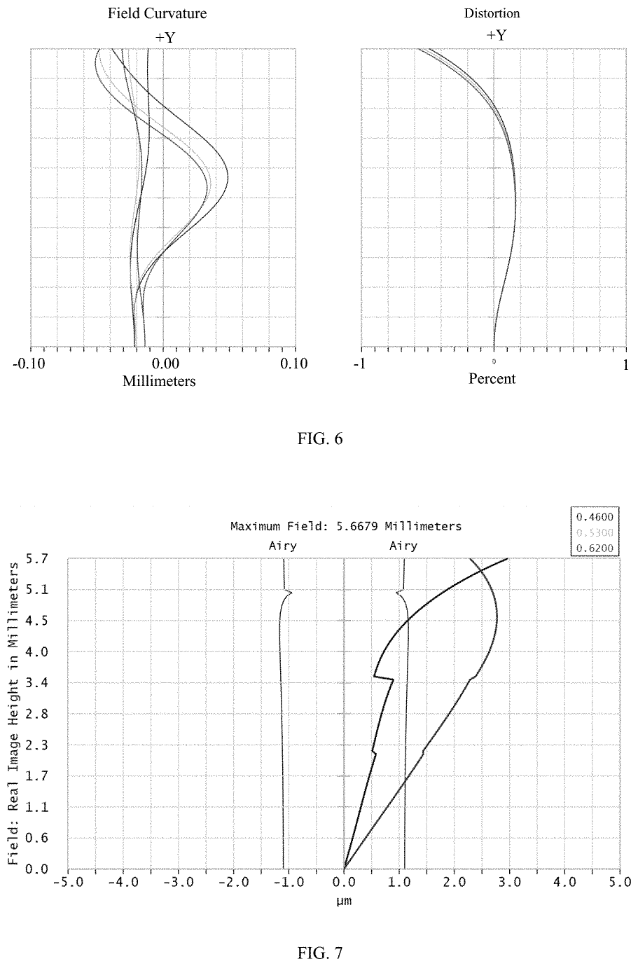

FIG. 6 is a schematic diagram of field curvature and distortion of a full field and full wave band of a projection lens according to an embodiment of the present disclosure, wherein the left part illustrates the field curvature, and the right part illustrates the distortion. As illustrated in FIG. 6, the field curvature of the projection lens is controlled to be less than 0.1 mm, and the distortion is controlled to be less than 0.74%.

FIG. 7 is a schematic diagram of vertical chromatic aberration of a full field and full wave-band of a projection lens according to an embodiment of the present disclosure. As illustrated in FIG. 7, the vertical chromatic aberration is not greater than 3 μm.

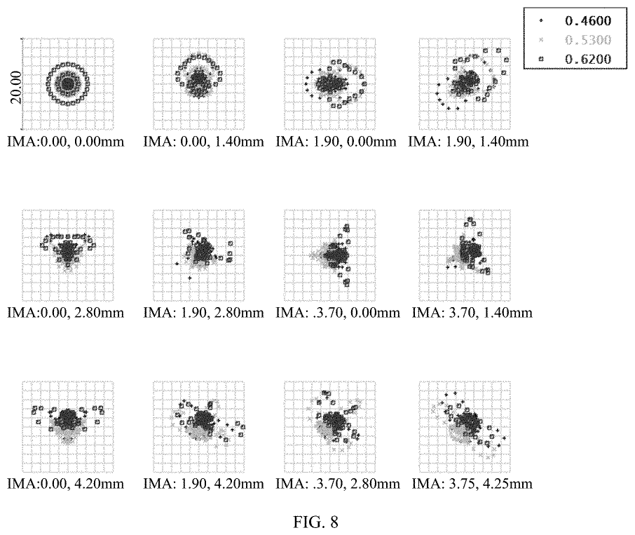

FIG. 8 is a schematic diagram of dot columns of a full field of a projection lens according to an embodiment of the present disclosure. As illustrated in FIG. 8, a root mean square (RMS) radius of the projection lens is controlled in the range of 2.0 μm<RMS<3.2 μm, and an average value is 2.7.

The embodiments of the present disclosure provide a projection lens. The projection lens includes a DMD chip, an equivalent prism, a vibrating mirror, a first refractive lens group, a diaphragm, and a second refractive lens group that are successively arranged; wherein the first refractive lens group includes a first lens, a triple-cemented lens, and a fifth lens that are successively arranged, wherein the triple-cemented lens includes a second lens, a third lens, and a fourth lens, the fourth lens being an aspherical lens. The triple-cemented lens has good correction capabilities on spherical aberration, chromatic aberration and secondary spectrum, such that a projection image projected from the projection lens has high definition, and the projection lens has a small size.

It should be noted that, the above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A projection lens, comprising a DMD chip, an equivalent prism, a vibrating mirror, a first refractive lens group, a diaphragm, and a second refractive lens group that are successively arranged;
wherein the first refractive lens group comprises a first lens, a triple-cemented lens, and a fifth lens that are successively arranged, wherein the triple-cemented lens comprises a second lens, a third lens, and a fourth lens, the fourth lens being an aspherical lens.

2. The projection lens according to claim 1, wherein
the second lens and the third lens are spherical glass lenses; and
the fourth lens comprises a first surface proximal to the third lens and a second surface proximal to the fifth lens, wherein the first surface is a spherical surface, and the second surface is an even-order aspherical surface.

3. The projection lens according to claim 1, wherein
the first lens and the fifth lens are spherical glass lenses.

4. The projection lens according to claim 2, wherein
the second refractive lens group comprises a sixth lens, a seventh lens, and an eighth lens that are successively arranged, wherein the eighth lens is a weak-focal power aspherical lens.

5. The projection lens according to claim 4, wherein
the sixth lens and the seventh lens are spherical glass lenses; and
the eighth lens is a plastic aspherical lens, and comprises a third surface proximal to the seventh lens and a fourth surface distal from the seventh lens, wherein the third surface and the fourth surface are both even-order aspherical surfaces.

6. The projection lens according to claim 5, wherein
the second refractive lens group further comprises a ninth lens, wherein the ninth lens is arranged in a light exit direction of the eighth lens and is a spherical glass lens.

7. The projection lens according to claim 6, wherein
the first lens has a positive focal power, the second lens has a negative focal power, the third lens has a positive focal power, the fourth lens has a negative focal power, the fifth lens has a positive focal power, the sixth lens has a positive focal power, the seventh lens has a negative focal power, the eighth lens has a negative focal power, and the ninth lens has a negative focal power.

8. The projection lens according to claim 7, wherein
the focal power φ7 of the seventh lens satisfies −0.06≤φ7≤−0.05, the focal power φ8 of the eighth lens satisfies −0.02≤φ8≤0, and the focal power φ9 of the ninth lens satisfies −0.03≤φ9≤−0.02.

9. The projection lens according to claim 1, wherein
the DMD chip has a physical resolution of 93 lp/mm.

10. The projection lens according to claim 1, further comprising a drive motor, connected to the vibrating mirror, and configured to drive the vibrating mirror to vibrate.

11. A projection lens, comprising a DMD chip, an equivalent prism, a vibrating mirror, a first refractive lens group, a diaphragm, and a second refractive lens group that are successively arranged;
wherein the first refractive lens group comprises a first lens, a triple-cemented lens, and a fifth lens that are successively arranged, and the second refractive lens group comprises a sixth lens, a seventh lens, an eighth lens and a ninth lens that are successively arranged; wherein the triple-cemented lens comprises a second lens, a third lens, and a fourth lens, the fourth lens being an aspherical lens; wherein the first lens, the third lens, the fifth lens and the sixth lens are convex lenses, and wherein the second lens, the fourth lens, the seventh lens, the eighth lens and the ninth lens are concave lenses.

12. The projection lens according to claim 11, wherein
the second lens and the third lens are spherical glass lenses; and
the fourth lens comprises a first surface proximal to the third lens and a second surface proximal to the fifth lens, wherein the first surface is a spherical surface, and the second surface is an even-order aspherical surface.

13. The projection lens according to claim 11, wherein
the first lens and the fifth lens are spherical glass lenses.

14. The projection lens according to claim 12, wherein
the eighth lens is a weak-focal power aspherical lens.

15. The projection lens according to claim 14, wherein
the sixth lens and the seventh lens are spherical glass lenses; and
the eighth lens is a plastic aspherical lens, and comprises a third surface proximal to the seventh lens and a fourth surface distal from the seventh lens, wherein the third surface and the fourth surface are both even-order aspherical surfaces.

16. The projection lens according to claim 15, wherein
the ninth lens is arranged in a light exit direction of the eighth lens and is a spherical glass lens.

17. The projection lens according to claim 16, wherein
the first lens has a positive focal power, the second lens has a negative focal power, the third lens has a positive focal power, the fourth lens has a negative focal power, the fifth lens has a positive focal power, the sixth lens has a positive focal power, the seventh lens has a negative focal power, the eighth lens has a negative focal power, and the ninth lens has a negative focal power.

18. The projection lens according to claim 17, wherein
the focal power φ7 of the seventh lens satisfies −0.06≤φ7≤−0.05, the focal power φ8 of the eighth lens satisfies −0.02≤φ8≤0, and the focal power φ9 of the ninth lens satisfies −0.03≤φ9≤−0.02.

19. The projection lens according to claim 11, wherein
the DMD chip has a physical resolution of 93 lp/mm.

20. The projection lens according to claim 11, further comprising a drive motor, connected to the vibrating mirror, and configured to drive the vibrating mirror to vibrate.
